(19) United States
(12) Patent Application Publication
(10) Pub. No.: US 2014/0051060 A1
(43) Pub. Date: Feb. 20, 2014

(54) SYSTEMS AND METHODS FOR SEPARATING COMPONENT MATERIALS OF A SUSPENSION USING IMMUNOMAGNETIC SEPARATION

(71) Applicant: RareCyte, Inc., (US)

(72) Inventors: Joshua Nordberg, Bainbridge Island, WA (US); Jennifer Chow, Seattle, WA (US); Arturo Ramirez, Seattle, WA (US); Jonathan Lundt, Seattle, WA (US); Jackie Lynn Stilwell, Sammamish, WA (US)

(73) Assignee: RareCyte, Inc., Seattle, WA (US)

(21) Appl. No.: 13/874,691

(22) Filed: May 1, 2013

Related U.S. Application Data
(60) Provisional application No. 61/641,169, filed on May 1, 2012.

(51) Int. Cl. G01N 1/34

(52) U.S. Cl. CPC G01N 1/34
USPC 435/2; 435/308.1

(57) ABSTRACT

This disclosure is directed to systems and methods for immunomagnetic separation of a target analyte of a suspension from the other component materials of the suspension. The system may be composed of a tube, a float, and a magnet. The magnet introduces a magnetic field or a magnetic gradient to the system. The system may also include a solution containing a particle to conjugate the target analyte to form a target analyte-particle complex. The particle is capable of being attracted by the magnetic field or magnetic gradient introduced by the magnet. The target analyte-particle complex may be attracted to the sidewall of the tube after the suspension undergoes density-based separation, such as by centrifugation.

### CROSS-REFERENCE TO A RELATED APPLICATION

This application claims the benefit of Provisional Application No. 61/641,169, filed May 1, 2012, which is hereby incorporated by reference in its entirety.

### TECHNICAL FIELD

This disclosure relates generally to immunomagnetic separation and, in particular, to systems and methods for separation of a target analyte of a suspension from the other component materials of the suspension with a magnetic field or magnetic gradient.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as fetal cells, endothelial cells, epithelial cells, parasites, bacteria, and inflammatory cells, and viruses, including HIV, cytomegalovirus, hepatitis C virus, and Epstein-Barr virus and nucleic acids. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 3 CTCs is considered clinically relevant in the diagnosis and treatment of a cancer patient. However, detecting even 1 CTC in a 7.5 ml blood sample may be clinically relevant and is equivalent to detecting 1 CTC in a background of about 40-50 billion red and white blood cells. Using existing techniques to find, isolate and extract as few as 3 CTCs of a whole blood sample is extremely time consuming, costly and is extremely difficult to accomplish.

As a result, practitioners, researchers, and those working with suspensions continue to seek systems and methods to more efficiently and accurately detect, isolate and extract target materials of a suspension.

### DESCRIPTION OF THE DRAWINGS

FIGS. 1A-1B show isometric views of two example tube and float systems.

FIG. 2 shows an isometric view of the example float of a tube and float system.

FIGS. 3-6 show examples of different types of floats.

FIG. 7 shows a flow diagram for separating a target analyte from a suspension.

FIGS. 8-10 shows example conjugations of a target analyte to a particle to form a target analyte-particle complex.

FIG. 11 shows an imaging process.

FIGS. 12A-12D show a tube and float system with example magnet configurations.

FIG. 13 shows a float being removed from a tube.

FIG. 14 shows an image of a cell.

### DETAILED DESCRIPTION

This disclosure is directed to systems and methods for immunomagnetic separation of a target analyte of a suspension from the other component materials of the suspension. The system may be composed of a tube, a float, and a magnet. The magnet introduces a magnetic field or a magnetic gradient to the system. The system may also include a solution containing a particle to conjugate with the target analyte to form a target analyte-particle complex. The particle is capable of being attracted by the magnetic field or magnetic gradient introduced by the magnet. The target analyte-particle complex may be attracted to the sidewall of the tube after the suspension undergoes density-based separation, such as by centrifugation.

Methods and systems for separating component materials of a suspension are disclosed. The detailed description is organized into two subsections: (1) A general description of various tube and float systems is provided in a first subsection. (2) Examples of methods and systems for separating component materials of suspensions using tube and float systems in which a magnetic field is introduced to attract and hold the target analyte to the tube are provided in a second subsection.

### General Description of Tube and Float System

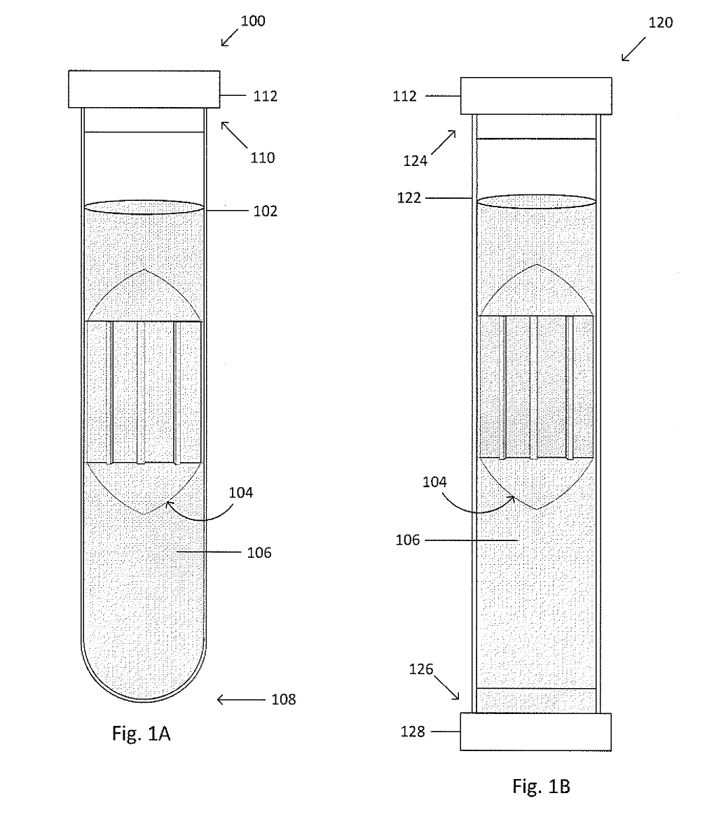

FIG. 1A shows an isometric view of an example tube and float system 100. The system 100 includes a tube 102 and a float 104 suspended within a suspension 106. In the example of FIG. 1A, the tube 102 has a circular cross-section, a first closed end 108, and a second open end 110. The open end 110 is sized to receive a stopper or cap 112. The tube may also have two open ends that are sized to receive stoppers or caps, such as the example tube and float system 120 shown FIG. 1B. The system 120 is similar to the system 100 except the tube 102 is replaced by a tube 122 that includes two open ends 124 and 126 configured to receive the cap 112 and a cap 128, respectively. The tubes 102 and 122 have a generally cylindrical geometry, but may also have a tapered geometry that widens, narrows, or a combination thereof toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material.

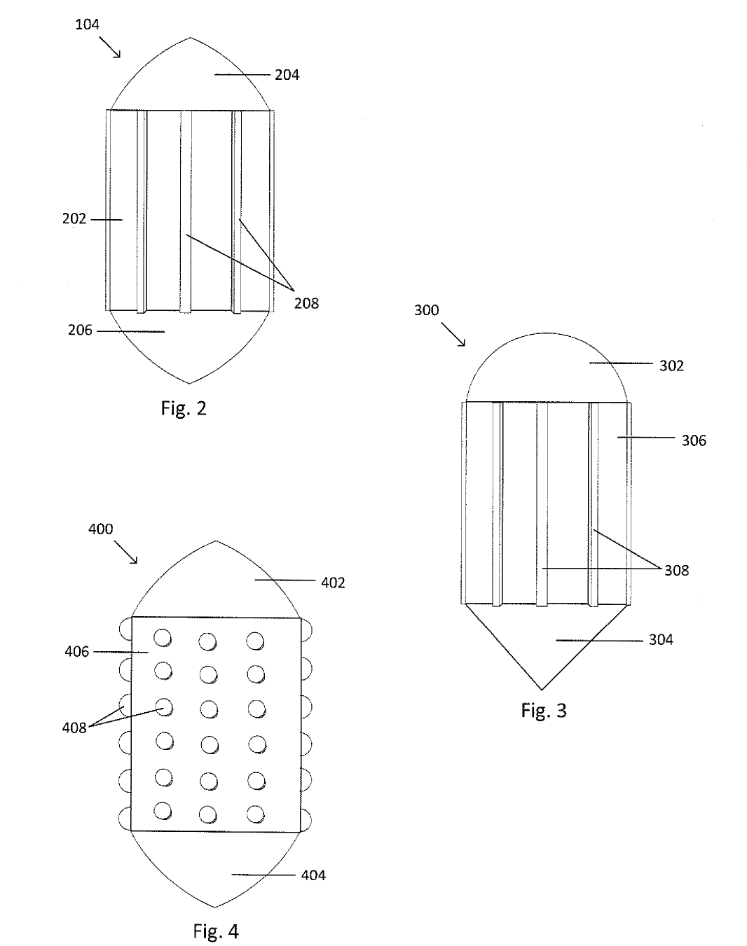

FIG. 2 shows an isometric view of the float 104 shown in FIG. 1. The float 104 includes a main body 202, two teardrop-shaped end caps 204, 206, and support members 208 radially spaced and axially oriented on the main body 202. A float can also include two dome-shaped end caps, two tangential end caps, or two cone-shaped end caps. The support members 208 engage the inner wall of the tube 102. In alternative embodiments, the number of support members, support member spacing, and support member thickness can each be independently varied. The support members 208 can also be broken or segmented. The main body 202 may be sized to have an outer diameter that is less than the inner diameter of the tube 102, thereby defining fluid retention channels between the outer surface of the body 202 and the inner wall of the tube 102. The surfaces of the main body 202 between the support members 208 can be flat, curved or have another suitable geometry. In the example of FIG. 2, the support members 208 and the main body 202 form a single structure.

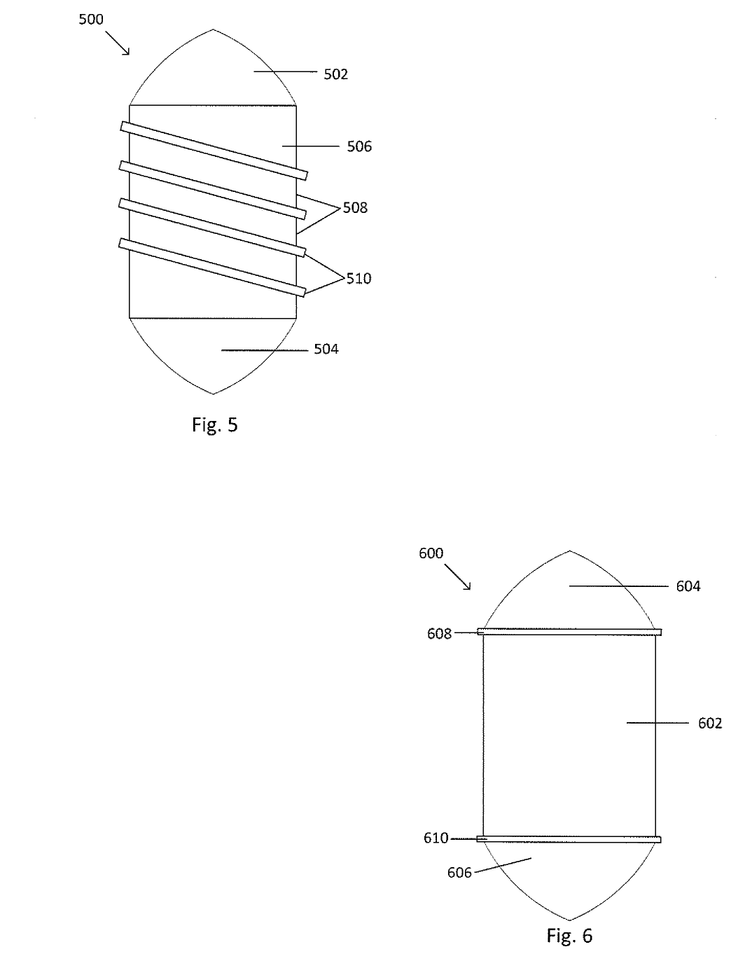

Embodiments include other types of geometric shapes for float end caps. FIG. 3 shows an isometric view of an example float 300 with a dome-shaped end cap 302 and a cone-shaped end cap 304. The main body 306 of the float 300 can includes the same structural elements (i.e., support members) as the float 104. A float can also include a teardrop-shaped end cap. The float end caps can include other geometric shapes and are not intended to be limited to the shapes described herein, such as a tangential cone.

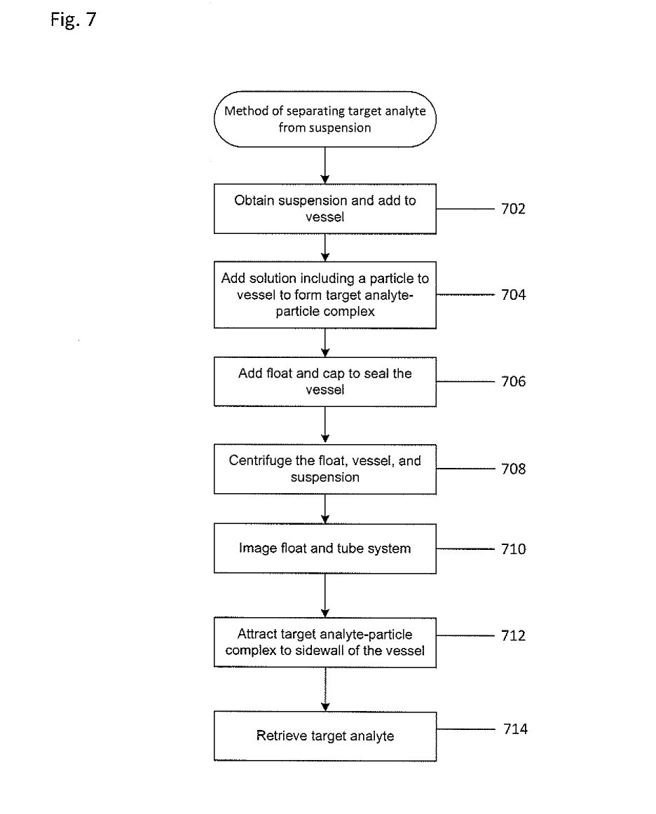

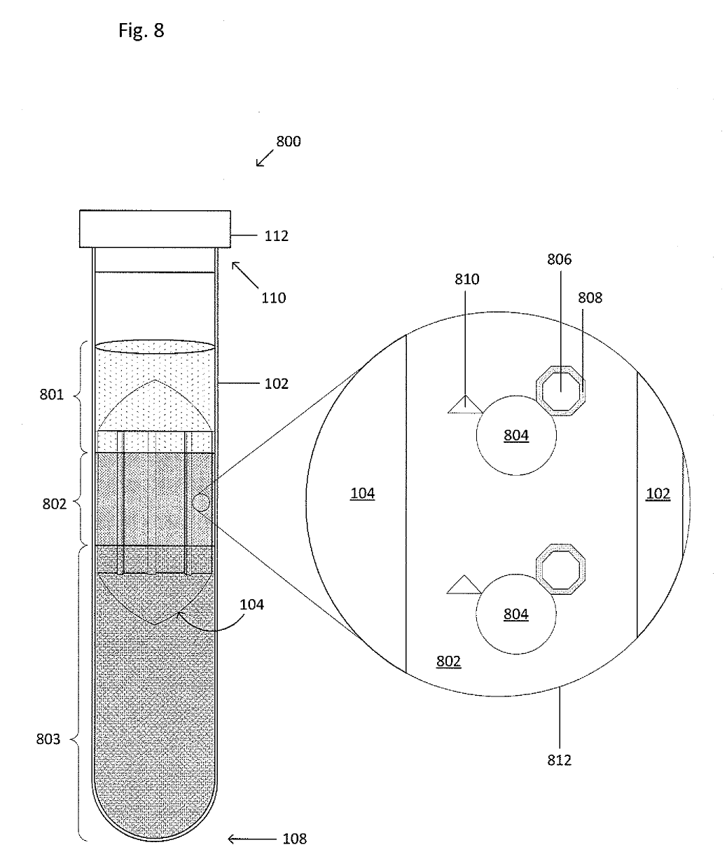

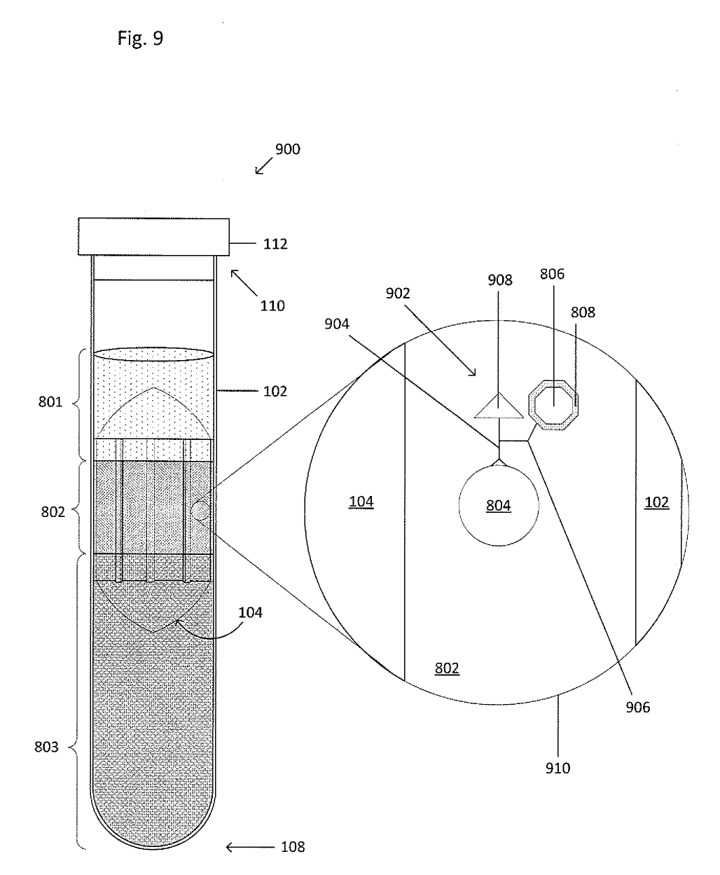

In other embodiments, the main body of the float 104 can include a variety of different support structures for separating target materials, supporting the tube wall, or directing the suspension fluid around the float during centrifugation. FIGS. 4, 5, and 6 show examples of three different types of main body structural elements. Embodiments are not intended to be limited to these three examples. In FIG. 4, the main body 402 of a float 400 is similar to the float 104 except the main body 402 includes a number of protrusions 404 that provide support for the tube. In alternative embodiments, the number and pattern of protrusions can be varied. In FIG. 5, the main body 502 of a float 500 includes a single continuous helical structure or ridge 504 that spirals around the main body 502 creating a helical channel 506. In other embodiments, the helical ridge 504 can be rounded or broken or segmented to allow fluid to flow between adjacent turns of the helical ridge 504. In various embodiments, the helical ridge spacing and rib thickness can be independently varied. In FIG. 6, a float 600 is similar to the float 104 except a main body 602 includes support members 608 and 610 extending circumferentially around the main body 602.

The float can be composed of a variety of different materials including, but not limited to, metals, including, but not limited to, aluminum, brass, gold, silver, tin, copper, bronze, chromium, cobalt, nickel, lead, iron, steel, manganese, zinc, neodymium, and combinations thereof; rigid organic or inorganic materials; ferrous plastics; sintered metal; machined metal; and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer, butyl rubber, ethylene propylene diene monomer, others, and combinations thereof.

The tube can be composed of a variety of different materials. The tube can be composed of glass; a rigid organic or inorganic materials; and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer, butyl rubber, ethylene propylene diene monomer, others, and combinations thereof.

The tube may have a sidewall and a first diameter. The float can be captured within the tube by an interference fit. To remove the float from the tube after the float has been captured, the sidewall, being elastically radially expandable to a second diameter, may be expanded in response to an axial load, pressure due to centrifugation, external vacuum, or internally-introduced pressure, the second diameter being sufficiently large to permit axial movement of the float in the tube during centrifugation. Alternatively, the support members may not engage the inner wall of the tube. Alternatively, the float may not include any support members.

### Methods and Systems for Separating Components of a Suspension

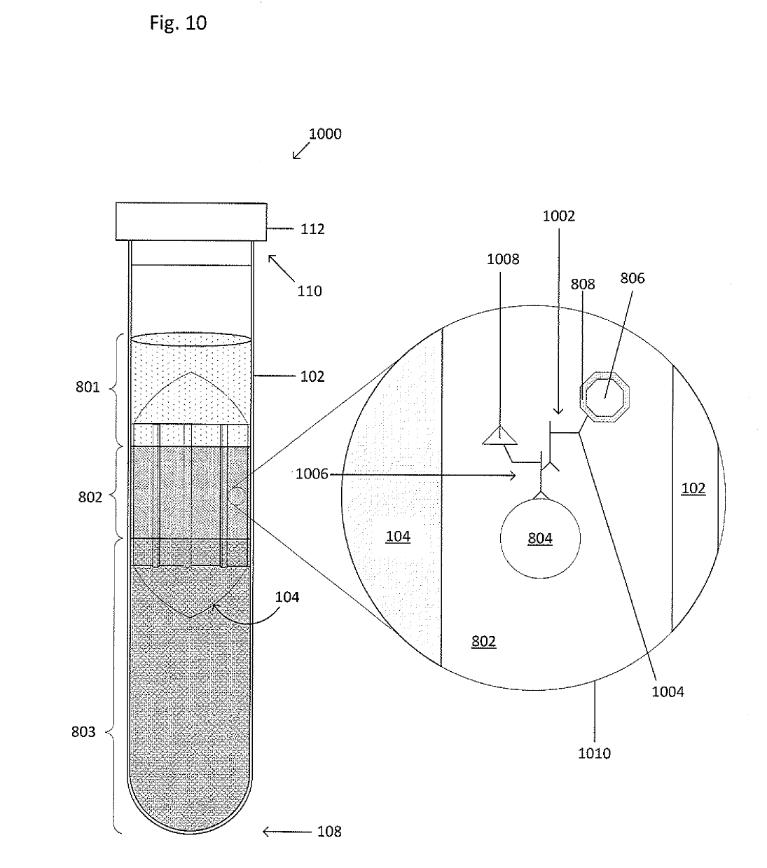

FIG. 7 shows a flow diagram for separating a target analyte from a suspension. In block 702, a suspension is obtained and then added to a vessel, such as a tube. In block 704, a solution including a particle to conjugate to a target analyte to form a target analyte-particle complex is added to the tube and incubated. For the sake of convenience, the suspension discussed herein is blood, though the suspension can be urine, blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. Furthermore, for the sake of convenience, the target analyte discussed herein is a circulating tumor cell (“CTC”), though the target analyte can be a cell, such as ova, a circulating endothelial cell, a vesicle, a liposome, a protein, a nucleic acid, a biological molecule, a naturally occurring or artificially prepared microscopic unit having an enclosed membrane, parasites, microorganisms, viruses, or inflammatory cells. The target analyte may be conjugated with the particle via direct conjugation, first-degree indirect conjugation, or second-degree indirect conjugation. Alternatively, the solution including the particle may be added to the suspension before the suspension is added to the vessel.

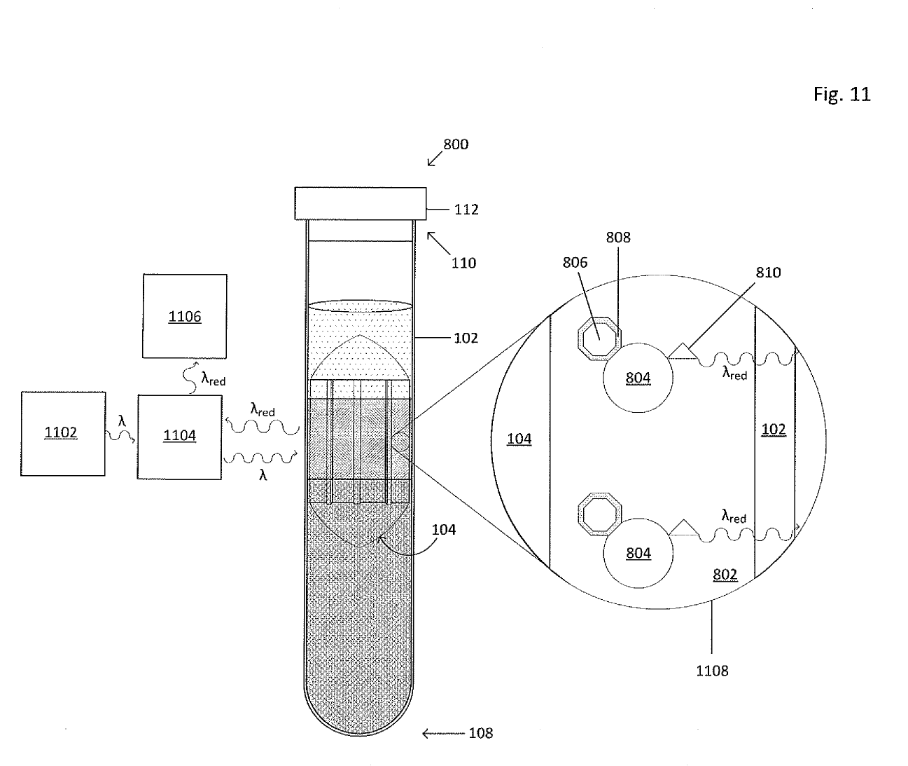

FIGS. 8-10 show isometric views of the tube and float system 800 having undergone density-based separation, such as by centrifugation. Suppose, for example, the suspension includes three fractions. The suspension separates into three fractions, with a highest density fraction 803 located on the bottom, a lowest density fraction 801 located on top, and a medium density fraction 802 located in between. The float 104 may have any appropriate density to settle within one of the fractions. The density of the float 104 can be selected so that the float 104 settles at the same axial position of the target analyte. The target analyte can be trapped within an analysis area between the float 104 and the tube 102. The float 104 decreases the distance between the target analyte and the magnet, thereby providing for a greater magnetic attraction.

FIG. 8 shows an isometric view of a tube and float system 800. The system 800 includes direct conjugation between a target analyte 804 and a particle 806, as shown in magnified view 812. The particle 806 includes a first molecule 808, the first molecule 808 having been coated, bound, or attached to an outer surface of the particle 806. The first molecule 808 is configured to bind directly to a second molecule of the target analyte 804. The first and second molecules are complementary conjugates. These complementary conjugates may bind to each other by covalent, ionic, dipole-dipole interactions, London dispersion forces, Van der Waal's forces, hydrogen bonding, or other chemical bonds. For example, the first molecule may be an EpCAM antibody and the second molecule on the target analyte may be an EpCAM antigen. The EpCAM antibody binds with the EpCAM antigen of the circulating tumor cell, as the EpCAM antibody and the EpCAM antigen are complementary conjugates. Furthermore, the target analyte 804 may be separately labeled with a fluorescent marker 810.

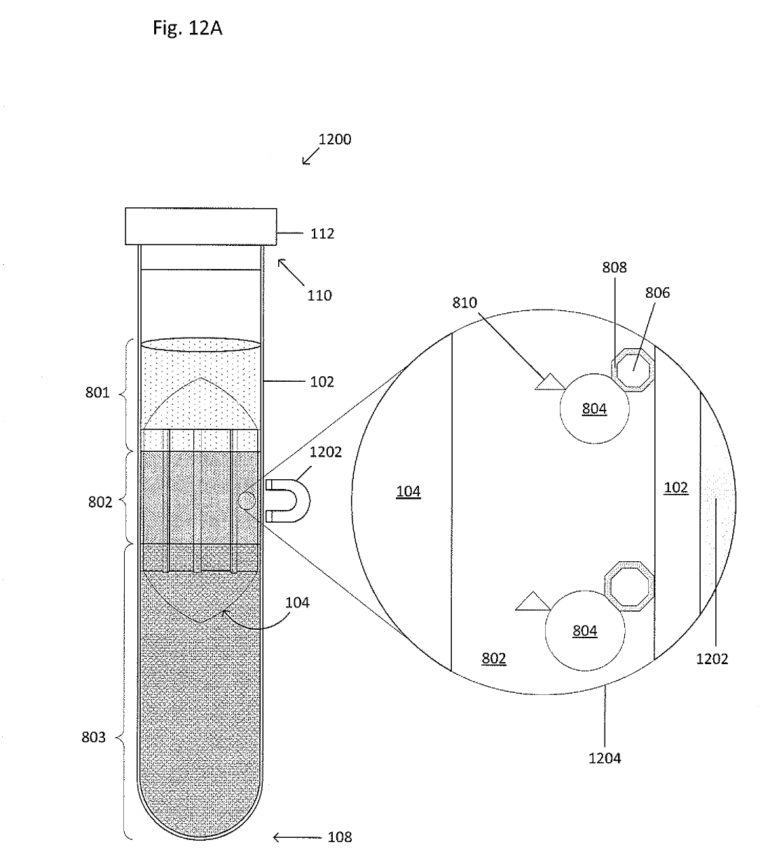

FIG. 9 shows an isometric view of a tube and float system 900. The system 900 includes first-degree indirect conjugation between the target analyte 804 and the particle 806, as shown in magnified view. For first-degree indirect conjugation, the target analyte 804 is conjugated with the particle 806 via a doubly-conjugated ligand 902. The particle 806 includes the first molecule 808. The doubly-conjugated ligand 902 is a ligand 904 that is “doubly conjugated” as it is bound to two distinct molecules, a second molecule 906 and a third molecule 908, such as a fluorescent molecule. The ligand 904 is a complementary conjugate to a molecule of the target analyte 804. The second molecule 906 is a complementary conjugate to that of the first molecule 808 such that the first molecule 808 and the second molecule 906 attract, and may also bind to, each other.

A doubly-conjugated ligand is a ligand which has been conjugated with two distinct molecules, such that the two molecules are not of the same composition or structure. The doubly-conjugated ligand provides a wide range of applications, such as a fluorescent linker between two articles, such that it is conjugated with a fluorescent marker and a distinct molecule so that the fluorescent marker emits a light signal upon excitation. The doubly-conjugated ligand provides a more functional way of linking two or more articles. The doubly-conjugated ligand may also amplify the detectable signal of the labeled article. To doubly conjugate the ligand, an unlabeled ligand may first be added to a reactive solution containing both a reactive first molecule and a reactive second molecule, such that the reactive first and second molecules are not of the same composition or structure. Next, the solution is incubated. The reactive second and third molecules compete for attachment to the unfilled conjugation sites of the ligand, thereby conjugating the ligand with some of the reactive second molecule and some of the reactive third molecule. In order to do this, however, a portion of the molar concentrations of each of the second and third molecules will be used, such that the total molar amount will be the same as when a single labeling reaction was done. Alternatively, the second and third molecules may be reactive with different conjugation chemistries.

Alternatively, to doubly conjugate a ligand, the ligand may be pre-labeled with the third molecule and then added to a solution comprising the reactive second molecule, such that the third molecule and the reactive second molecule are not of the same composition or structure. Next, the solution is incubated. The reactive second molecule will attach to at least one of the unfilled conjugation sites on the ligand pre-labeled with the third molecule.

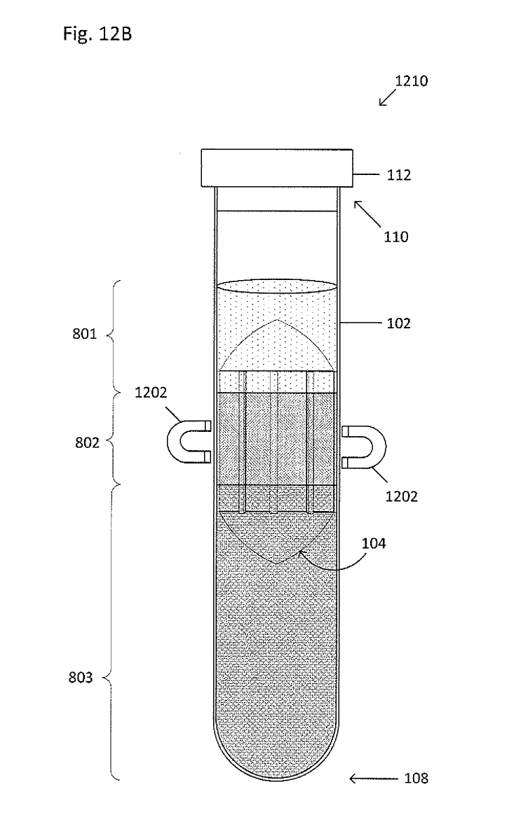

FIG. 10 shows an isometric view of a tube and float system 1000. The system 1000 includes second-degree indirect conjugation between the target analyte 804 and the particle 806, as shown in magnified view 1010. The particle 806 includes the first molecule 808. A first intermediary 1002 includes a second molecule 1004. The particle 806 and the first intermediary 1002 bind, as the first and second molecules 808 and 1004 are complementary conjugates. A second intermediary 1006, being bound with a fluorescent molecule 1008, binds with the target analyte 804 and the first intermediary 1002. The first and second intermediaries 1002 and 1006 are complementary conjugates or include complementary conjugates bound thereto. The second intermediary 1006 is a complementary conjugate to a molecule of the target analyte 804.

Regarding FIGS. 8-10 the first and second molecules are complementary conjugates that than a bond with each other, thereby directly or indirectly binding any article to which the first and second molecules are already attached. These complementary conjugates may bind to each other by covalent, ionic, dipole-dipole interactions, London dispersion forces, Van der Waal's forces, hydrogen bonding, or any chemical bond.

Alternatively, the particle may be bound to the first intermediary, such that the first intermediary is an anti-fluorophore antibody. The second intermediary includes one or more fluorophores, such that the first intermediary, being the anti-fluorophore antibody, binds to a fluorophore of the second intermediary. The second intermediary binds to the target analyte.

The particle may come in any form, including, but not limited to, a bead, a nanoparticle (such as a quantum dot), a shaving, a filing, or the like, such that the particle is capable of being attracted by a magnetic field or magnetic gradient introduced by a magnet. The particle may itself be magnetic, diamagnetic, ferromagnetic, paramagnetic, or superparamagnetic. The particle 1014 may be composed of a variety of different materials including, but not limited to, metals, including, but not limited to, aluminum, brass, gold, silver, tin, copper, bronze, chromium, cobalt, nickel, lead, iron, steel, manganese, zinc, neodymium, and combinations thereof at least one organic material, at least one inorganic material, at least one mineral, at least one ferrofluid, at least one plastic, at least one polymer and combinations thereof.

Returning to FIG. 7, in block 706, a float is added to the vessel and a cap seals the vessel. In block 708, the float, the tube, and the suspension undergo density-based separation, such as by centrifugation, thereby permitting separation of the suspension into density-based fractions along an axial position in the tube based on density.

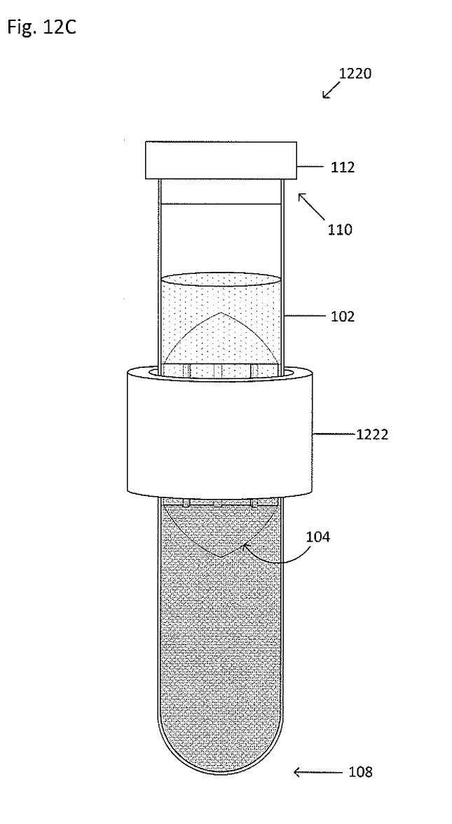

In block 710, the tube and float system may be imaged. FIG. 11 shows an imaging process. To image the tube and float system 800 having undergone density-based separation, an analysis area is illuminated with one or more wavelengths of excitation light from a light source 1102, such as red, blue, green, and ultraviolet. A solution containing the fluorescent marker 810 may be used to label the target analyte 804, thereby providing a fluorescent signal for identification and characterization. The solution containing the fluorescent marker 810 may be added to the suspension before the suspension is added to the vessel, after the suspension is added to the vessel but before centrifugation, or after the suspension has undergone centrifugation. The fluorescent marker 810 includes a fluorescent molecule bound to a ligand. The target analyte 804 may have a number of different types of surface markers. Each type of surface marker is a molecule, such as an antigen, capable of attaching a particular ligand, such as an antibody. As a result, ligands can be used to classify the target analyte and determine the specific type of target analytes present in the suspension by conjugating ligands that attach to particular surface markers with a particular fluorescent molecule. Examples of suitable fluorescent molecules include, but are not limited to, quantum dots; commercially available dyes, such as fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”); combinations of dyes, such as CY5PE, CY7APC, and CY7PE; and synthesized molecules, such as self-assembling nucleic acid structures. Many solutions may be used, such that each solution includes a different type of fluorescent molecule bound to a different ligand.

The excitation light is focused by an objective 1104 onto the analysis area, which is a space between the float and tube in which a target analyte may be retained or trapped. The different wavelengths excite different fluorescent markers, causing the fluorescent markers to emit light at lower energy wavelengths. A portion of the light emitted by the fluorescent markers is captured by the objective 1104 and transmitted to a detector 1106 that generates images that are processed and analyzed by a computer or associated software or programs. The images formed from each of the channels can be overlaid when a plurality of fluorescent markers, having bound themselves to the target analyte, are excited and emit light. The light source 1102 and the objective 1104 may be separate pieces or may be one piece. The light source 1102 and the objective 1104 may be coaxial or may be located on different planes. The target analyte 804 can then be characterized, and its location identified, based on the light emission(s) from the fluorescent marker(s) 810 attached to the target analyte 804.

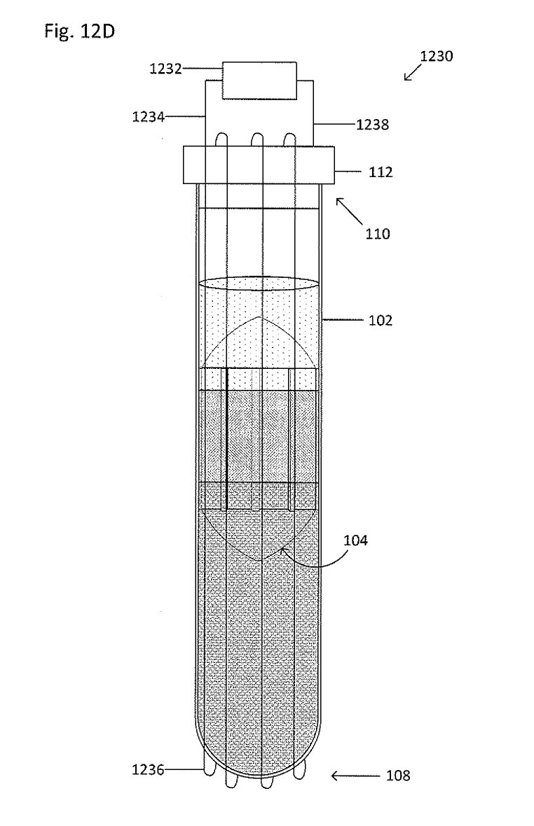

Returning to FIG. 7, in block 712, the target analyte-particle may be attracted to the sidewall of the vessel. FIG. 12A shows a float and tube system 1200 with a magnet 1202 outside an outer surface of the tube 102. The magnet 1202 creates a magnetic field or a magnetic gradient through the tube 102. The magnetic field or magnetic gradient passes through the sidewall of the tube 102 to attract the target analyte-particle complex to the sidewall of the tube 102. The magnet 602 may touch the outer surface of the tube 102 or may not touch the outer surface of the tube 102. Attracting and holding the target analyte-particle complex to the tube 102 via the magnet 1202 may permit using fluidics to wash, fix, permeabilize, and/or label the target analyte. The force of the magnetic field or the magnetic gradient, being greater than the forces produced by the flow-thru, holds the target analyte-particle complex within the tube 102 while the flow-thru force removes the non-target analytes and unwanted materials.

FIG. 12B shows a float and tube system 1210. The system 1210 is similar to the system 1200 except that the system 1210 includes more than one magnet 602 outside the outer surface of the tube 102.

FIG. 12C shows a float and tube system 1220. The system 1220 is similar to the system 1200 except that the system 1220 includes a magnet 1222 that surrounds the outer surface of the tube 102. The magnet 1222 may surround the full length of the tube 102 or any portion thereof, such as the full length of the float 104.

FIG. 12D shows a float and tube system 1230. The system 1230 is similar to the system 1200 except that the system 1230 includes an electromagnet. The electromagnet includes a power source 1232, such as a battery, DC or AC current supply, external to, disposed on or within the cap 112, a first lead 1234, a coil 1236, and a second lead 1238. The electromagnet may also include a switch or control mechanism.

The magnet includes, but is not limited to, a ring magnet, a bar magnet, a horseshoe magnet, an electromagnet, a switchable magnet, a spherical magnet, a polygon-shaped magnet, a polyhedral shape, a wand magnet, a kidney-shaped magnet, a trapezoidal magnet, a disk magnet, a cow magnet, or a block or brick magnet. When more than one magnet is used, the magnets may be different or the same in both size and shape.

Returning to FIG. 7, in block 714, the target analyte may be retrieved. To retrieve the target analyte, the target analyte may be pipetted or poured out of the tube. Prior to retrieval, the system may also undergo a washing step or a series of washing steps to remove any unwanted material or non-target analytes. The target analyte may be retrieved when the float is still present within the tube or after the float has been removed from the tube.

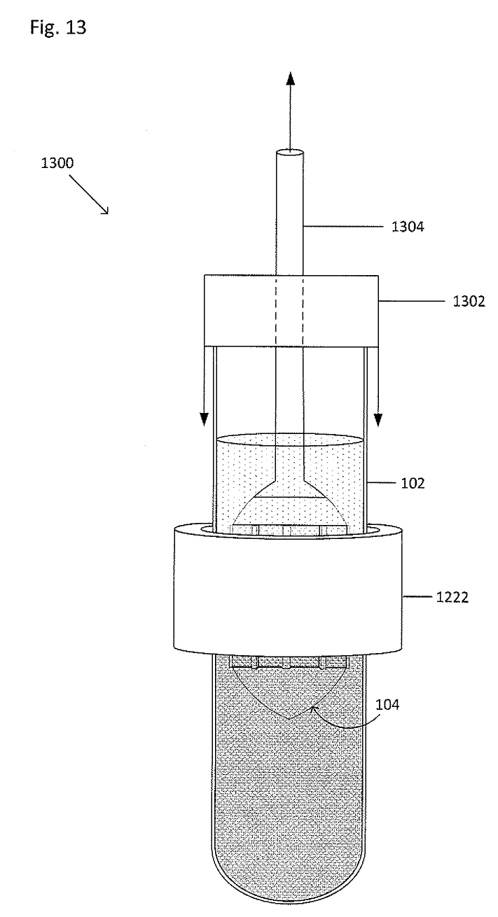

FIG. 13 shows the float 104 being removed from the tube 102. To remove the float 104 from the tube 102, a weighted object 1302 may be placed on top of the tube 102 to apply an axial load, so to cause the tube 102 to expand, thereby providing clearance to remove the float 800 manually or with a removing tool 1304. Alternatively, a force may be applied, in any appropriate manner, to the top or bottom of the tube 102, so to cause expansion. Alternatively, the tube and float system may be inserted into an adapter and a vacuum is then drawn between the tube and the adapter. The pressure differential causes the tube to expand within the adapter. Alternatively, the tube may be separated. The tube may be separated by splitting, bifurcating, pulling apart, cutting, or tearing the tube. After separating the tube, the float may be removed.

### Biological Applications

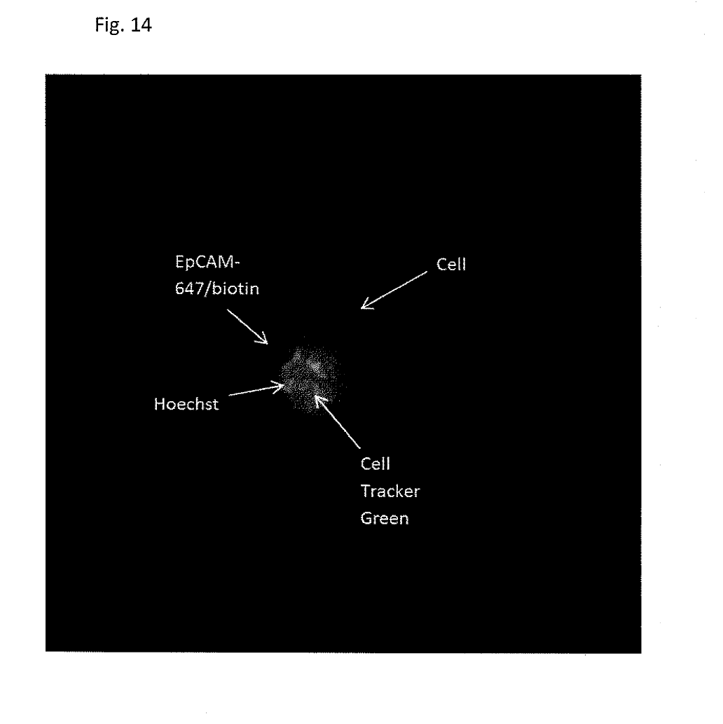

Referring now to FIG. 14, an image of a cell that has been pre-labeled with Hoechst and Celltracker™ green is shown. Cells were spiked into a blood sample in a tube and were then labeled with the doubly conjugated particles. Streptavidin-coated beads and biotinylated EpCAM antibodies labeled with Alexa Fluor 647 were used. The streptavidin-coated beads attracted the biotin molecule of the biotinylated EpCAM antibodies labeled with Alexa Fluor 647. The EpCAM antibody bound to an EpCAM biomarker on the cell. The tube was then centrifuged with a float. Magnets were placed in substantial contact with the tube. The float was removed. The blood was then removed. Phosphate buffered saline (“PBS”) was added to wash away non-target analytes and to maintain an appropriate environment for the cells. The magnets were removed. The PBS-cell solution was decanted into a second tube. The tube was placed in substantial contact with a magnet. The PBS-cell solution was transferred into a third tube, resuspended, and placed in substantial contact with a magnet. The PBS-cell solution was transferred, resuspended, and mounted on a slide where the cells were counted and imaged. The Alexa Fluor 647 provided a red fluorescent emission light when excited for detection and characterization. Hoechst provided a blue fluorescent emission and Celltracker™ green provided a green fluorescent emission.

The target analyte may be analyzed using any appropriate analysis method or technique, though more specifically extracellular and intracellular analysis including intracellular protein labeling; nucleic acid analysis, including, but not limited to, DNA arrays, expression arrays, protein arrays, and DNA hybridization arrays; in situ hybridization (“ISH”—a tool for analyzing DNA and/or RNA, such as gene copy number changes); polymer chain reaction (“PCR”); reverse transcription PCR; or branched DNA (“bDNA”—a tool for analyzing DNA and/or RNA, such as mRNA expression levels) analysis. These techniques require fixation, permeabilization, and isolation of the target analyte prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist1, Snail1, ZEB1, Fibronectin, Slug, Ki-67, M30, MAGEA3, phosphorylated receptor kinases, modified histones, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, enzyme-conjugated antibodies, Pap stain, Giemsa stain, or hematoxylin and eosin stain) may be used.

In direct conjugation, the first molecule of the particle bonds directly with the CTC. In first-degree indirect conjugation, the particle having a first molecule is conjugated to the CTC via a doubly-conjugated ligand. The doubly-conjugated ligand is bound to a second molecule and a third molecule. The second molecule is a complementary molecular conjugate to that of the first molecule such that the first molecule and the second molecule bond to each other. In second-degree indirect conjugation, the CTC is conjugated to the particle via the first intermediary particle bound to a second molecule and the fluorescent marker-conjugated second intermediary particle while in the tube or prior to introduction into the tube.

The first molecule of the particle, whether introduced to the particle through binding, coating, or attaching, may include, but is not limited to, an avidin, such as streptavidin or neutravidin; Protein A, Protein G, Protein L; biotin; an aptamer; a primary antibody that binds to biomarkers, including but not limited to, EpCAM, AMACR, Androgen receptor, CD146, CD227, CD235, CD24, CD30, CD44, CD45, CD56, CD71, CD105, CD324, CD325, CD133, CAIX, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

The first and second molecules are complementary molecular conjugates that will indirectly bind and attach any particle to which they are already attached by binding and attaching to each other. The second molecule may include, but is not limited to, an avidin, such as streptavidin or neutravidin; Protein A, Protein G, Protein L; biotin; an aptamer; a primary antibody that binds to biomarkers, including but not limited to, EpCAM, AMACR, Androgen receptor, CD146, CD227, CD235, CD24, CD30, CD44, CD45, CD56, CD71, CD133, CD324, CD325, CAIX, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

On a doubly-conjugated ligand, the third molecule may include, but is not limited to, a fluorescent marker; alkaline phosphatase; an avidin, such as streptavidin or neutravidin; Protein A, Protein G, Protein L; biotin; an aptamer; a primary antibody that binds to biomarkers, including but not limited to, EpCAM, AMACR, Androgen receptor, CD146, CD227, CD235, CD24, CD30, CD44, CD45, CD56, CD71, CD105, CD324, CD325, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; IgG, IgM; scFv, Fab, sdAb; an antibody-like molecule that binds to a biomarker; or a second antibody.

The first and second intermediaries may include, but are not limited to an avidin, such streptavidin or neutravidin; biotin; a protein; an antibody, including but not limited to, EpCAM, AMACR, Androgen receptor, CD146, CD227, CD235, CD24, CD30, CD44, CD45, CD56, CD71, CD105, CD324, CD325, MUC1, CEA, cMET, EGFR, Folate receptor, HER2, Mammaglobin, or PSMA; a ligand, such as EGF, HGF, TGFα, TGFβ superfamily of ligands, IGF1, IGF2, Wnt signaling proteins, FGF signaling ligands, amphiregulin, HB-EGF, neuregulin signaling ligands, MSP, VEGF family of ligands, betacellulin, epiregulin, epigen, hedgehog signaling ligands; or an aptamer.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

I/We claim:

1. A system for separating a target analyte from a suspension, the system comprising:
a float to be inserted within a tube;
a tube having a first inner diameter dimensioned to receive the float;
a magnet to introduce a magnetic field or a magnetic gradient; and,
a solution containing a particle to conjugate with the target analyte, wherein when the float and the solution combined with the suspension are added to the tube and the magnet introduces the magnetic field of the magnetic gradient to the tube, the particle will attract the target analyte to an inner surface of the tube.

2. The system of claim 1, wherein the magnet is external to the tube.

3. The system of claim 2, wherein the magnet is a permanent magnet.

4. The system of claim 3, further comprising more than one magnet.

5. The system of claim 3, wherein the magnet surrounds the outer surface of the tube.

6. The system of claim 2, wherein the magnet is an electromagnet or a switchable magnet.

7. The system of claim 1, wherein the particle is conjugated to the target analyte to form the target analyte-particle complex via a doubly-conjugated ligand.

8. The system of claim 1, wherein the particle is directly conjugated to the target analyte to form the target analyte-particle complex.

9. The system of claim 1, wherein the particle is conjugated to the target analyte to form the target analyte-particle complex via at least two intermediaries.

10. The system of claim 9, wherein a first intermediary is an anti-fluorophore antibody, wherein a second intermediary includes one or more fluorophores, wherein the first intermediary binds to one of the one or more fluorophores of the second intermediary, and wherein the second intermediary binds to the target analyte.

11. The system of claim 1, wherein the target analyte is trapped in an analysis area between an outer surface of the float and the inner wall of the tube to bring the target analyte closer to the magnet.

12. A method for separating a target analyte from a suspension, the method comprising:
inserting a float into the tube;
introducing the suspension to the tube;
introducing a solution to the tube, wherein the solution contains a particle to conjugate with the target analyte, wherein when the float and the solution combined with the suspension are added to the tube and the magnet introduces the magnetic field of the magnetic gradient to the tube, the particle will attract the target analyte to an inner surface of the tube;
centrifuging the tube and the float to effect a density-based separation of the suspension; and,
introducing a magnetic field or magnetic gradient to the tube to attract and hold the target analyte-particle complex to a sidewall of the tube,
wherein the suspension is added before or after the float is introduced to the tube, and
wherein the solution is added before or after the suspension or the float are introduced to the tube.

13. The method of claim 12, wherein the magnetic field or magnetic gradient is introduced via at least one magnet external to the tube.

14. The method of claim 13, wherein the at least one magnet is a permanent magnet.

15. The method of claim 14, wherein the at least one magnet surrounds the outer surface of the tube.

16. The method of claim 13, wherein the at least one magnet is an electromagnet or a switchable magnet.

17. The method of claim 12, further comprises labeling the target analyte with at least one fluorescent marker and applying a stimulus to cause the at least one fluorescent marker attached to the target analyte to emit light that distinguishes the target analyte from other materials contained in the suspension.

18. The method of claim 13, further comprises removing the float from the tube with the magnetic field or magnetic gradient still in place to hold the target analyte-particle complex to the sidewall of the tube.

19. The method of claim 13, further comprises removing the non-target analytes and unwanted materials from the tube.

20. The method of claim 13, further comprises extracting the target analyte-particle complex from the tube.
